(19) United States
(12) Patent Application Publication
(10) Pub. No.: US 2010/0032554 A1
(43) Pub. Date: Feb. 11, 2010

(54) Neutron Polarization Apparatus

(76) Inventors: Hirohiko Shimizu, Saitama (JP); Jun-ichi Suzuki, Ibaraki (JP); Takayuki Oku, Ibaraki (JP)

Correspondence Address: WENDEROTH, LIND & PONACK, L.L.P., 1030 15th Street, N.W.,, Suite 400 East, Washington, DC, 20005-1503, US

(21) Appl. No.: 11/992,848

(22) PCT Filed: Nov. 1, 2006
(86) PCT No.: PCT/JP2006/321864

§ 371 Date: Sep. 29, 2009

(30) Foreign Application Priority Data
Nov. 1, 2005 (JP) 2005-318621

(51) Int. Cl. H05H 3/02

(52) U.S. Cl. 250/251

(57) ABSTRACT

A neutron polarization apparatus is provided that provides a neutron beam polarized by an interaction between a spin of a neutron in an incident neutron beam and a magnetic field. The apparatus includes a quadrupole magnet (2) disposed around a passage of a neutron beam, a tubular neutron absorber (3) provided in the quadrupole magnet (2) along am axial direction of the neutron beam, and a solenoid coil (4) disposed at an exit of the quadrupole magnet (2), adiabatically coupling the quadrupole magnetic field produced by the quadrupole magnet (2) and applying a bipolar magnetic field. The neutron polarization apparatus can polarize a neutron with a high polarization unavailable in the prior art.

### TECHNICAL FIELD

The present invention relates to a neutron polarization apparatus capable of polarizing a neutron so that it has an extremely high polarization.

### BACKGROUND ART

A polarized neutron is an extremely useful probe in neutron scattering studies, and essential in elucidation of magnetic structures, studies on dynamics, such as relaxation phenomena using neutron spin echo techniques, and removal of incoherent scattering. Further, a polarized neutron plays a significantly important role in neutron-based studies in fundamental physics. To obtain a polarized neutron, methods using magnetic crystals or magnetic multilayer films have been available, and in recent years, a method using polarized ³He gas is available. Development of neutron polarization apparatus having novel features and excellent performance is significantly important to make advances in techniques used in neutron scattering study.

The concept of using the interaction between the spin of a neutron and a magnetic field to obtain a polarized neutron should be relatively easily conceivable for neutron scattering researchers. In practice, however, from the fact that the interaction energy between the spin of a neutron and a magnetic field is extremely small, fabrication of a neutron polarization apparatus with practical functions by using an available magnet has been believed to be difficult. Further, even if such a neutron polarization apparatus can be fabricated, the apparatus will be huge in size, and hence has been considered impractical.

From these reasons, there have been no attempts to use the interaction between the spin of a neutron and a magnetic field to develop an apparatus for obtaining a polarized neutron.

On the other hand, the inventors of the present application have been pursuing the research and development of a focusing-type small-angle scattering apparatus (F-SANS) using a sextupole magnet, and have reported the results of the study in JP-A-10-247599. The sextupole magnet described in JP-A-10-247599 serves as an ideal lens for a neutron. When the neutron has a positive polarity, the sextupole magnet functions as a focusing lens (a sextupole magnet used to focus a neutron beam is hereinafter also referred to as a neutron magnetic lens), while when the neutron has a negative polarity, the sextupole magnet serves as a diverging lens. When a neutron magnetic lens is used to focus neutrons, a very precisely focused neutron beam can be obtained because there is no material that absorbs or scatters neutrons. A neutron magnetic lens is therefore considered to be highly suitable as a neutron focusing element used in a focusing-type small-angle scattering apparatus. However, if incident neutrons contain negative polarity components, such components diverge through the sextupole magnet and spread over the detector surface, resulting in an increased background level. To overcome this problem, when a sextupole magnet is used as the neutron focusing element in a focusing-type small-angle scattering apparatus, it is necessary to polarize incident neutrons so that they have very high polarization (the polarization should be on the order of 0.99 or higher).

For cold neutrons, the polarization P can be on the order of 0.99 by using a magnetic mirror polarizing element in some cases. However, it has been difficult to obtain higher polarization.

### DISCLOSURE OF INVENTION

The present invention has been made in view of the circumstances of related art described above. An object of the invention is to provide a neutron polarization apparatus capable of polarizing a neutron so that it has a high polarization unavailable in the prior art.

To achieve the above object, according to the present invention, 1) there is provided a neutron polarization apparatus that provides a neutron beam polarized by an interaction between a spin of a neutron in an incident neutron beam and a magnetic field, comprising a quadrupole magnet disposed around a passage of the neutron beam, a tubular neutron absorber provided in the quadrupole magnet along an axial direction of the neutrons, and a solenoid coil disposed at an exit of the quadrupole magnet, adiabatically coupling the quadrupole magnetic field produced by the quadrupole magnet and applying a bipolar magnetic field.

2) In the first aspect of the invention, there is provided the neutron polarization apparatus, wherein the quadrupole magnet is a four-piece magnet.
3) In the first aspect of the invention, there is provided the neutron polarization apparatus, wherein the quadrupole magnet is a Halbach-type magnet.
4) In the first aspect of the invention, there is provided the neutron polarization apparatus, wherein characterized in that the quadrupole magnet is an advanced Halbach-type magnet.
5) In any one of the first to fourth aspects of the invention, there is provided the neutron polarization apparatus, wherein the neutron absorber is made of Cd.

According to the present invention, employing any of the configurations described above allows an excellent neutron polarization apparatus capable of polarizing a neutron so that it has a high polarization unavailable in the prior art.

Further, the present invention can provide a neutron polarization apparatus characterized by, in addition to the above excellent advantage, a high transmittance (an extremely high transmittance, no absorption or scattering, and an extremely high efficiency), linear installation capability (beam axis controlling capability), maintenance-free, high stability, and compactness (the design is believed to be optimum in a sense that the apparatus is compact as a magnetic field-based polarizing element).

### BRIEF DESCRIPTION OF DRAWINGS

FIG. 1 is a longitudinal cross-sectional view diagrammatically showing the structure of a neutron polarization apparatus using a quadrupole magnet according to the present invention;

FIG. 2 is a transverse cross-sectional view diagrammatically showing the structure of the quadrupole magnet used in the neutron polarization apparatus according to the present invention;

FIG. 3 shows how a neutron behaves when it enters a sextupole magnetic field;

FIG. 4 shows the temporal change in the intensity distribution of a neutron beam that has entered a quadrupole magnetic field and a sextupole magnetic field;

FIG. 5 is a cross-sectional view diagrammatically showing the configuration of an experimental setup using the neutron polarization apparatus of an example according to the present invention;

FIG. 6 shows the resultant two-dimensional intensity distributions of neutrons for various conditions by using the experimental setup shown in FIG. 5;

FIG. 7 shows the results of experiments conducted after a Cd tube inserted into the quadrupole magnet is removed;

FIG. 8 shows neutron intensity distribution data obtained by carrying out an experiment in which measurement of the polarization and background measurement are alternately repeated in a short period of time in order to take into account of systematic errors;

FIG. 9 diagrammatically shows the configuration of an experimental setup for focusing-type small-angle scattering experiments using a Halbach-type quadrupole magnet as a neutron polarizing element;

FIG. 10 shows two-dimensional distributions of the neutron intensity obtained by using the apparatus shown in FIG. 9;

FIG. 11 shows radial average values of the neutron intensities; and

FIG. 12 shows the results obtained by measuring small-angle scattering of SiO₂ particles using the experimental setup shown in FIG. 9.

### BEST MODE FOR CARRYING OUT THE INVENTION

An embodiment of the present invention having the features described above will be described below.

First, consider the properties of a neutron. A neutron is a particle that, along with a proton, forms an atomic nucleus. Although a neutron is electrically neutral, it has a magnetic moment and can be considered as a tiny magnet. Although a neutron is electrically neutral and has a magnetic moment, the magnitude of the magnetic moment is so small (approximately a thousandth of that of an electron) that it is not easy to control a neutron beam by using a magnetic field. Further, a neutron has a spin ½-angular momentum, and the magnetic moment of a neutron can be oriented in two directions, parallel and anti-parallel to the magnetic field vector.

The inventors of the present application have focused on such properties of a neutron and intensively investigated the possibility of using the interaction between the magnetic moment of a neutron and a magnetic field to obtain a neutron beam having a high polarization. When a neutron enters a space with a magnetic field intensity gradient, either a force in one direction or a force in the opposite direction is exerted on the neutron depending on its polarity. By using this phenomenon to spatially separate neutrons completely into those having one polarity component and those having the other polarity component and extracting one of the two groups, the resultant neutrons have, in principle, a polarization P being one (P=1). Whether or not such an approach is successful depends on whether or not a steep magnetic field intensity gradient can be formed in a large space. To produce a steep magnetic field intensity gradient in a large space, the inventors have conducted a study on the use of a quadrupole magnet. As a result, the inventors have ascertained that the use of a quadrupole magnet allows efficient generation of a steep magnetic field intensity gradient in a large space, so that the spin of a neutron can be polarized and it has a very high polarization P. The inventors have thus attained the present invention.

As described above, the neutron polarization apparatus of the present invention uses the interaction between the spin of a neutron in an incident neutron beam and a magnetic field so as to obtain a polarized neutron beam. The neutron polarization apparatus includes a quadrupole magnet. A tubular neutron absorber is provided in the quadrupole magnet. Further, a solenoid coil is disposed at the exit of the quadrupole magnet. The solenoid coil not only adiabatically couples the quadrupole magnetic field produced by the quadrupole magnet but also applies a bipolar magnetic field. That is, in the quadrupole magnet, the magnetic field vectors are distributed in various directions in a plane perpendicular to the axis of the neutron beam. Since the neutrons are polarized by local magnetic fields, the spins of the neutrons are also distributed in various directions. Therefore, to spatially align the directions of the neutron spins distributed in various directions and extract a polarized neutron beam, the solenoid coil is disposed at the exit of the quadrupole magnet and a bipolar magnetic field parallel to the axis of the neutron beam is applied.

The quadrupole magnet can be a typical four-piece quadrupole magnet, while use of a Halbach-type quadrupole magnet or an advanced Halbach-type quadrupole magnet enhances the resultant magnetic field intensity by a factor of several times the intensity produced by a typical four-piece quadrupole magnet. Such an approach is therefore significantly useful to obtain polarized neutrons, each having a high polarization P, in a relatively compact volume.

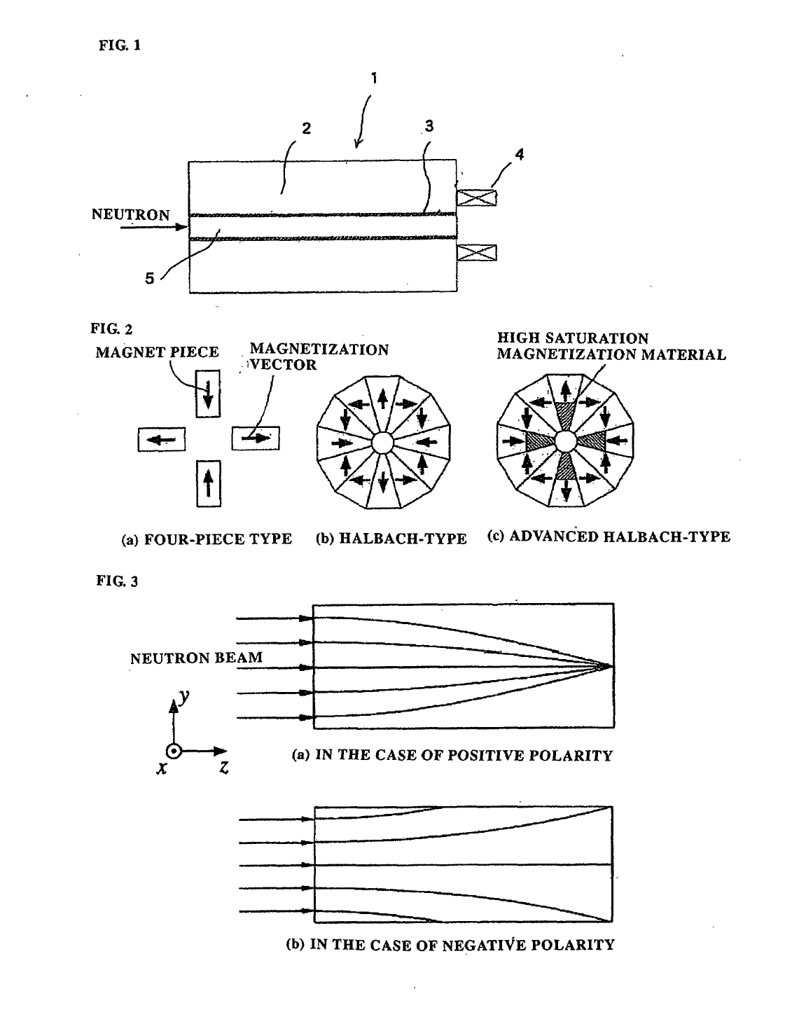

FIG. 1 is a longitudinal cross-sectional view diagrammatically showing the structure of a neutron polarization apparatus using a quadrupole magnet according to the present invention. In the figure, reference numeral (1) denotes the neutron polarization apparatus. A tubular member (3) made of a neutron absorbing material is disposed in a quadrupole magnet (2), and a solenoid coil (4) is disposed at the exit of the quadrupole magnet (2). Reference numeral (5) denotes the passage for neutrons.

FIG. 2 is a transverse cross-sectional view diagrammatically showing the structure of the quadrupole magnet used in the neutron polarization apparatus according to the present invention.

The principle underlying the present invention will now be described.

The motion of a neutron in a magnetic field is expressed by the following two equations:

$$\begin{matrix}\frac{{d}^{2} r}{d {t}^{2}} = - α ∇ ( σ \cdot B ) & ( 1 ) \\ \frac{d σ}{d t} = {γ}_{n} σ \times B & ( 2 )\end{matrix}$$

In the equations, reference character r denotes the coordinate vector of the neutron. Reference character σ denotes a unit vector parallel to the neutron spin. Reference character α satisfies the following equation: α=|μₙ/mₙ|=5.77 m²s⁻²T⁻¹. Reference character γₙ denotes the gyromagnetic ratio (=2μₙ/h=−1.83×10⁸ s⁻¹T⁻¹; h denotes Dirac's h). The equations (1) and (2) show that the neutron is accelerated in the magnetic field along the gradient of the inner product of the spin of the neutron and the magnetic field vector, and that the spin of the neutron precesses at a Larmor frequency ω_{L}=−γₙ|B| (B denotes the magnetic field vector). When the neutron flies through a non-uniform magnetic field, the magnetic field vector at the position of the neutron changes. Now, define the rotational angular frequency of that magnetic field vector to be ω_{B}=|∂B/∂s|ds/dt. In this equation, reference character s denotes the coordinate vector along the trajectory of the neutron, and reference character B denotes a unit vector in the magnetic field. When the magnetic field intensity is sufficiently high and the following relationship is satisfied: ω_{L}/ω_{B}>>1, the state of the spin of the neutron is substantially preserved, and the neutron is transported in an adiabatic manner. In this case, the equation of motion of the neutron in the magnetic field is simply expressed by the following equation:

$$\frac{{d}^{2} r}{d {t}^{2}} = ∓ α ∇ \vert B \vert \qquad ( 3 )$$

In the equation, the negative sign “−” corresponds to the state in which the neutron spin has a positive polarity (the neutron spin is parallel to the magnetic field vector), whereas the positive sign “+” corresponds to the state in which the neutron spin has a negative polarity (the neutron spin is anti-parallel to the magnetic field vector). The quadrupole magnetic field vector B_{q} is expressed by the following equation:

$${B}_{q} = - 2 {G}_{q} ( \begin{matrix}x \\ - y \\ 0\end{matrix} ) \qquad ( 4 )$$

In this equation, G_{q} denotes the magnetic field intensity gradient constant. The distribution of the quadrupole magnetic field intensity is expressed by the following equation:

|B_{q}|=2G_{q}\sqrt{x²+y²} (5)

By substituting the equation (5) into the equation (3), the equation of motion of the neutron in the quadrupole magnetic field is obtained as follows:

$$\frac{{d}^{2} x}{d {t}^{2}} = ∓ α \frac{2 {G}_{q} x}{\sqrt{{x}^{2} + {y}^{2}}} , \\ \frac{{d}^{2} y}{d {t}^{2}} = ∓ α \frac{2 {G}_{q} y}{\sqrt{{x}^{2} + {y}^{2}}} , \\ \frac{{d}^{2} z}{d {t}^{2}} = 0 \qquad ( 6 )$$

The equation (6) cannot be analytically solved. For the sake of simplicity, the trajectory of the neutron is limited to y=0. Then, the following equation is obtained:

$$\frac{{d}^{2} x}{d {t}^{2}} = ∓ 2 {G}_{q} α \qquad ( 7 )$$

The equation (7) shows that a constant force is exerted on the neutron independent of the position thereof. The direction of the force is oriented toward the central axis of the magnet when the spin of the neutron has a positive polarity, whereas the neutron receives the force in the direction away from the central axis of the magnet when the spin of the neutron has a negative polarity.

For reference, a description is also made of the case of a sextupole magnetic field.

The sextupole magnetic field vector Bₛ is expressed by the following equation:

$${B}_{S} = \frac{{G}_{S}}{2} ( \begin{matrix}{y}^{2} - {x}^{2} \\ 2 xy \\ 0\end{matrix} ) \qquad ( 8 )$$

In this equation, Gₛ denotes the magnetic field intensity gradient constant indicative of the magnitude of the magnetic field intensity gradient. From the equation (8), the distribution of the sextupole magnetic field intensity is expressed by the following equation:

$$\vert {B}_{s} \vert = \frac{{G}_{S}}{2} ( {x}^{2} + {y}^{2} ) \qquad ( 9 )$$

By substituting the equation (9) into the equation (3), the equation of motion of a neutron in the sextupole magnetic field is obtained as follows:

$$\frac{{d}^{2} x}{d {t}^{2}} = ∓ {ω}^{2} x , \frac{{d}^{2} y}{d {t}^{2}} = ∓ {ω}^{2} y , \frac{{d}^{2} z}{d {t}^{2}} = 0 \qquad ( 10 )$$

In this equation, Ω²=Gₛα. The equation (10) can be analytically solved, and the solution is given as follows:
(i) In the case of a positive polarity,

$$\begin{matrix}x ( t ) = x ( 0 ) cos ( \frac{ω {m}_{n} λ}{h} z ( t ) ) + \frac{{v}_{x} ( 0 )}{ω} sin ( \frac{ω {m}_{n} λ}{h} z ( t ) ) & ( 11 ) \\ y ( t ) = y ( 0 ) cos ( \frac{ω {m}_{n} λ}{h} z ( t ) ) + \frac{{v}_{y} ( 0 )}{ω} sin ( \frac{ω {m}_{n} λ}{h} z ( t ) ) & ( 12 ) \\ z ( t ) = {v}_{z} ( 0 ) t = \frac{h}{{m}_{n} λ} t & ( 13 )\end{matrix}$$

In these equations, λ denotes the wavelength of the neutron along the z axis, and vᵢ(0) denotes the i (=x, y, and z)-direction component of the speed of the neutron at the time t=0. When the neutron enters the sextupole magnetic field in parallel to the z axis, the neutron is focused at z=πh/(2 Ωmₙλ) (FIG. 3(a)).
(ii) In the case of a negative polarity,

$$\begin{matrix}x ( t ) = x ( 0 ) cosh ( \frac{ω {m}_{n} λ}{h} z ( t ) ) + \frac{{v}_{x} ( 0 )}{ω} sinh ( \frac{ω {m}_{n} λ}{h} z ( t ) ) & ( 14 ) \\ y ( t ) = y ( 0 ) cosh ( \frac{ω {m}_{n} λ}{h} z ( t ) ) + \frac{{v}_{y} ( 0 )}{ω} sinh ( \frac{ω {m}_{n} λ}{h} z ( t ) ) & ( 15 ) \\ z ( t ) = {v}_{z} ( 0 ) t = \frac{h}{{m}_{n} λ} t & ( 16 )\end{matrix}$$

The neutron beam that has entered the sextupole magnetic field is accelerated and diverges in the direction away from the central axis of the magnetic field (FIG. 3(b)).

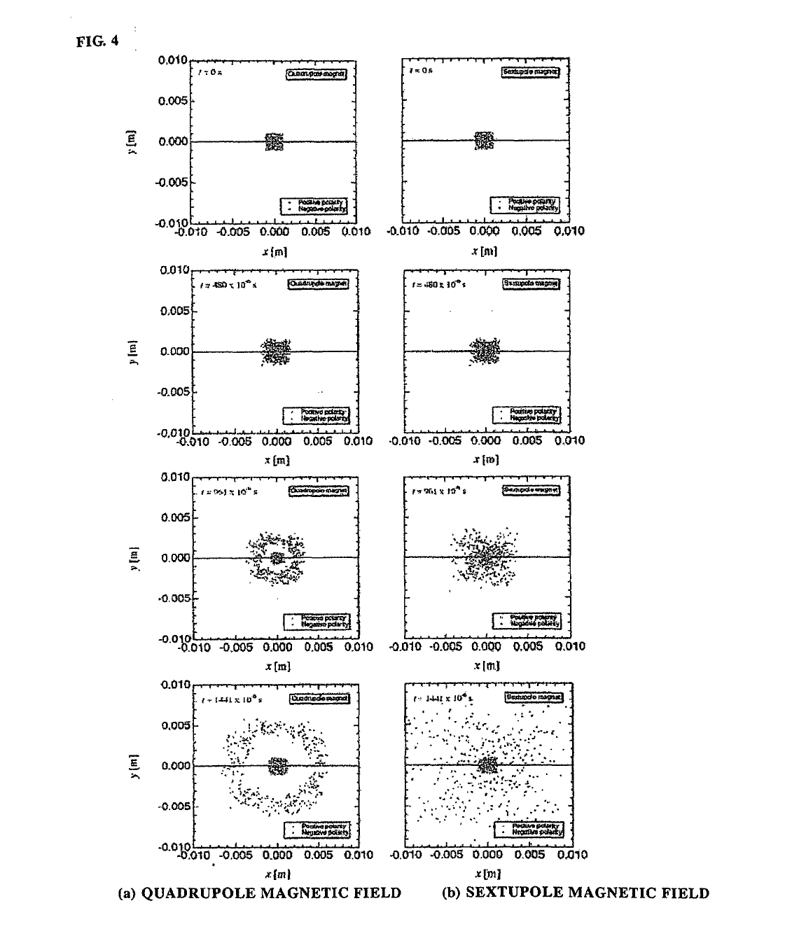

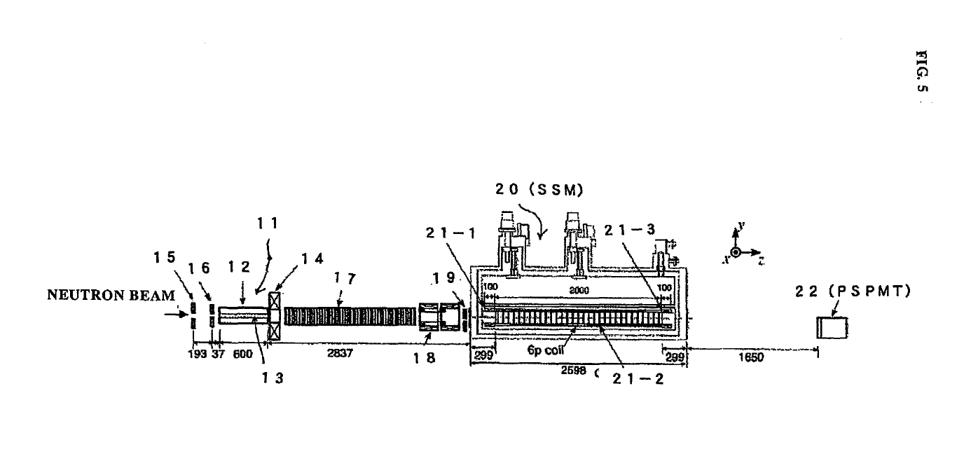

To understand how the intensity distribution of a neutron beam that has entered a quadrupole magnetic field changes, FIG. 4(a) shows the temporal change in the neutron beam intensity distribution calculated by using the equation (6). For the sake of comparison, FIG. 4(b) shows a relationship similar to that shown in FIG. 4(a) but for a sextupole magnetic field. In the figures, the size of the incident beam was 2 mm by 2 mm. The maximum speed component normal to the beam axis was 0.8 m/s. The beam was incident on the central axis of each of the magnetic fields. Each of the magnetic field intensity gradient constants for the quadrupole and sextupole magnetic fields was determined in such a way that the maximum magnetic field intensity became 2 T provided that the inner diameter of the magnet is 5 mmφ. For the quadrupole magnetic field, G_{q}=400 T/m, and for the sextupole magnetic field, Gₛ=640000 T²/m. FIG. 4 shows that for the quadrupole magnetic field, the positive and negative polarity components are spatially separated completely from each other when the time t has reached 1 msec. On the other hand, for the sextupole magnetic field, although the negative polarity component spreads with time, the positive and negative polarity components are not completely separated. It is therefore appreciated that, as compared to the sextupole magnetic field, the quadrupole magnetic field, which produces a uniform magnetic field intensity gradient in the magnet, is suitable to be used as the spin polarizing element.

The present invention will be described below in more detail with reference to examples. The present invention is not of course limited to the above embodiment or the following examples, but it is needless to say that the details can be implemented in various aspects.

### EXAMPLES

FIG. 5 is a cross-sectional view diagrammatically showing the configuration of an experimental setup using the neutron polarization apparatus of an example according to the present invention.

In FIG. 5, reference numeral (11) denotes the neutron polarization apparatus including a Halbach-type quadrupole magnet (12) (hereinafter also simply referred to as a quadrupole magnet (12)). The Halbach-type quadrupole magnet (12) has an axial length of approximately 600 mm. In the Halbach-type quadrupole magnet (12) is disposed a tubular neutron absorber (13) made of Cd (hereinafter also referred to as Cd tube), which extends in the axial direction and has a 5 mm-diameter hollow portion through which neutrons pass. The neutron absorber (13) is provided to prevent neutrons from being reflected off the inner surface of the quadrupole magnet (12), and formed of a 0.5 mm-thick, spirally coiled Cd plate. At the downstream end of the quadrupole magnet (12) is disposed a solenoid coil (Sc0) (14) for magnetic field coupling that can apply a bipolar magnetic field. On the upstream side of the quadrupole magnet (12) are disposed a φ5 slit (15) and a φ2 slit (16).

On the downstream side of the solenoid coil (Sc0) (14) is disposed a guiding magnetic field coil (17) for applying a guiding magnetic field, and at the exit of the guiding magnetic field coil (17) is disposed a spin flipper (18). On the downstream side of the spin flipper (18) are disposed a φ2 slit (19) and a superconducting sextupole magnet (SSM) (20). The superconducting sextupole magnet (SSM) (20) is provided to evaluate the polarization P of the neutron beam polarized by the neutron polarization apparatus (11), and includes solenoid coils for magnetic field coupling (21-1) and (21-3) as well as a center solenoid coil (21-2). On the downstream side of the superconducting sextupole magnet (SSM) (20) is disposed a position-sensitive photomultiplier (PSPMT) (22).

Monochromatic neutrons used in this example have a wavelength λ of 9.5 angstroms. A neutron beam that has been stopped down by the φ5 slit (15) and the φ2 slit (16) into a smaller-diameter beam was incident on the central axis of the quadrupole magnet (12) in the neutron polarization apparatus (11). To adiabatically couple the quadrupole magnetic field to a bipolar magnetic field at the portion where the neutrons emerge through the quadrupole magnet (12), the solenoid coil (Sc0) (14) was used to apply a bipolar magnetic field. The neutrons that had passed through the neutron polarization apparatus (11) passed through the guiding magnetic field coil (17) and then the spin flipper (18), and entered the superconducting sextupole magnet (SSM) through the φ2 slit (19). Then, the superconducting sextupole magnet (SSM) (20) was used to evaluate the polarization P of the neutron beam that emerged through the neutron polarization apparatus (11).

When the neutrons enter the sextupole magnetic field of the superconducting sextupole magnet (SSM) (20), the spin component having a positive polarity is accelerated toward the central axis of the sextupole magnetic field, whereas the negative polarity component is accelerated in the direction away from the central axis. Therefore, when an off-axis, collimated neutron beam enters the sextupole magnetic field, the neutron beam is spatially separated into two. The ratio between the separated neutrons can be used to determine the polarization P of the neutron beam. To this end, at the portion immediately upstream of the superconducting sextupole magnet (SSM) (20) is disposed the φ2 slit (19), the position of which is shifted from the central axis of the superconducting sextupole magnet (SSM) (20) by −5 mm in the x direction and −3 mm in the y direction. Thus disposed slit (19) allows an off-axis, collimated neutron beam to enter the superconducting sextupole magnet (SSM) (20). The neutron beam that had passed through the superconducting sextupole magnet (SSM) (20) was detected by the position-sensitive photomultiplier (PSPMT) (22) having a neutron scintillator ZnS attached to the light-receiving surface thereof, and the spatial distribution of the intensity of the detected neutron beam was measured.

The current I_{SSM} applied to the center solenoid coil (21-2) in the superconducting sextupole magnet (SSM) (20) was 240 A, and the current I_{SOL0} applied to the solenoid coils for magnetic field coupling (21-1) and (21-3) was 80 A.

The experimental setup configured as shown in FIG. 5 was used to measure the neutron intensity distribution on the downstream side of the superconducting sextupole magnet (SSM) (20) under the following conditions:

Condition 1: The current I_{Sc0} applied to the solenoid coil for magnetic field coupling (Sc0) (14) is 0 A, and the spin flipper (18) is off.

Condition 2: I_{Sc0}=40 A, and spin flipper (18) is off.

Condition 3: I_{Sc0}=40 A, and spin flipper (18) is on.

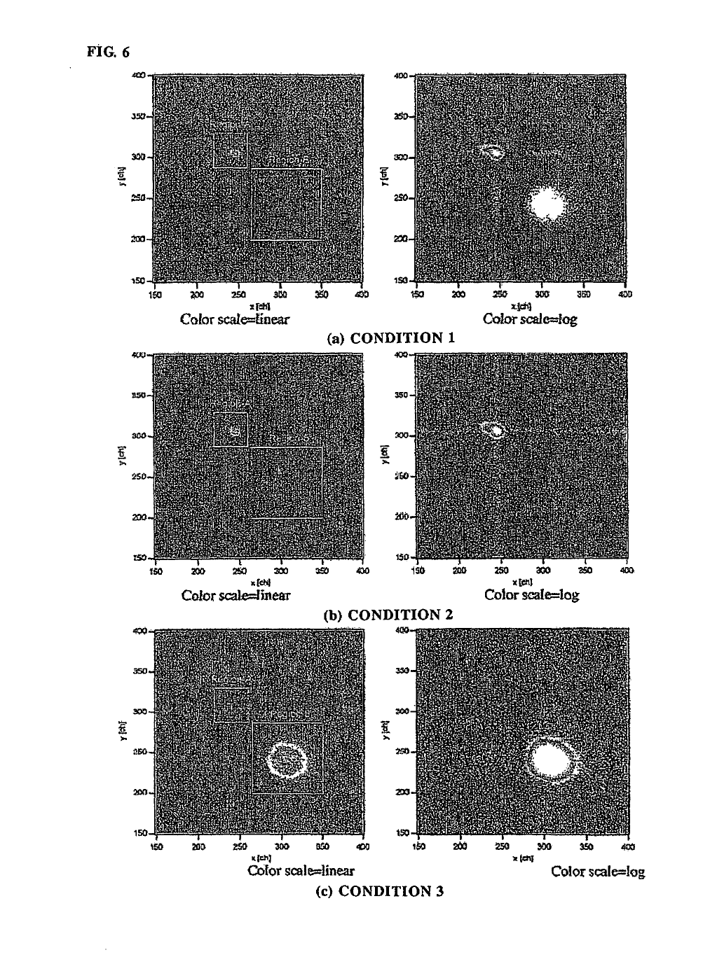

FIG. 6 shows the resultant two-dimensional intensity distributions of the neutrons for the above conditions. For clarity, the color scale is drawn both in a linear scale and a Log scale for each of the above conditions.

The result for the condition 1 shows that a spot having the intensity indicative of a neutron was observed in each of Region-A and Region-B. It is considered that the spot in Region-A corresponds to the positive polarity component of the neutrons focused by the superconducting sextupole magnet (SSM) (20), and the spot in Region-B corresponds to the negative polarity component of the neutrons diverged by the superconducting sextupole magnet (SSM) (20). In the figure in Log-scale, streaks intersecting at the position of the small spot in Region-A are observed. Such streaks are not true signals but artifacts produced by a defect in a signal processing circuit in the detector (22).

The result for the condition 2 shows that, as long as the two-dimensional intensity distribution of the neutron intensity is concerned, a spot was observed in Region-A, whereas no spot or no spot-like object was observed in Region-B. The result for the condition 3 shows that, in contrast to the result for the condition 2, a spot was observed in Region-B, whereas no spot or no spot-like object was observed in Region-A. The experimental results described above can be interpreted as follows:

1) Under the conditions 2 and 3, almost 100% of the neutrons that passed through the quadrupole magnet (12) in the neutron polarization apparatus (11) and then entered the superconducting sextupole magnet (SSM) (20) were polarized. The spin flipping efficiency of the spin flipper (18) disposed immediately upstream the superconducting sextupole magnet (SSM) (20) was also almost 100%. When the spin flipper (18) was turned on and off, the region in which a spot appears was flipped between Region-A and Region-B.
2) Under the condition 1, since the current I_{Sc0} applied to the solenoid coil for magnetic field coupling (Sc0) (14) was 0 A, the neutron spin was depolarized in the vicinity of the exit of the quadrupole magnet.

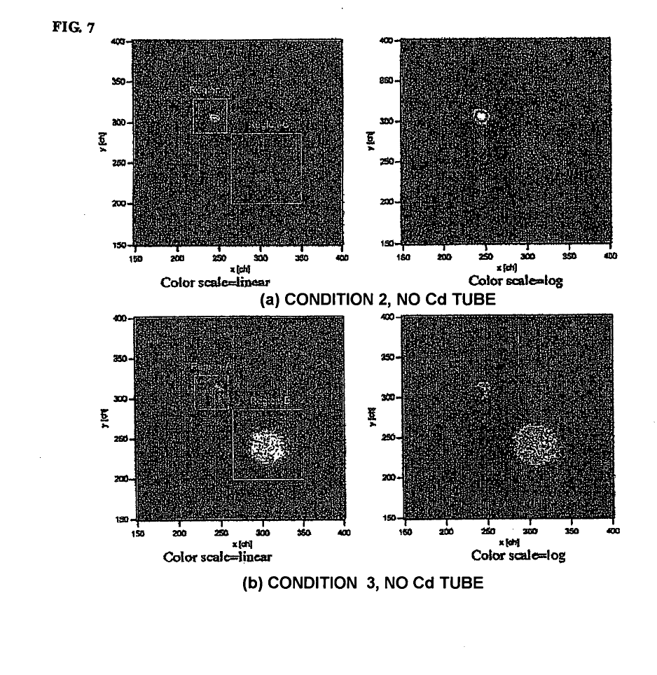

Then, the Cd tube, which was inserted into the quadrupole magnet in order to prevent the neutrons from being reflected off the inner surface of the quadrupole magnet, was removed, and experiments were conducted under the conditions 2 and 3. FIG. 7 shows the results.

FIG. 7 shows that a spot appeared in the other region where no spot was observed in FIG. 6. The reason of this is considered to be the absence of the Cd tubular member (13), that is, that the negative-polarity spin component that was diverged by the quadrupole magnet (12) was reflected off the inner surface of the quadrupole magnet (12) and entered the beam path of the positive-polarity component. (When a simulation is carried out by assuming that the inner surface of the quadrupole magnet (12) is an ideal cylindrical surface, and that all neutrons that have impinged on the inner surface are reflected, the result shows that the negative-polarity component is found on the same beam path of the positive-polarity component.)

Then, for each of the above conditions, the polarization P of the neutron beam was quantitatively evaluated. Let I₊ and I₋ be the neutron intensities obtained by subtracting background values from integral values of the neutron intensity in Region-A and Region-B, respectively. The background values were determined from the data obtained in the measurement conducted with the beam shutter closed. Then, the following equation was used to evaluate the polarization P.

$$P = \frac{{I}_{+} - {I}_{-}}{{I}_{+} + {I}_{-}} \qquad ( 17 )$$

Table 1 shows the polarization obtained for the respective conditions described above.

TABLE 1

| Conditions | poralization P |
|---|---|
| Condition 1 (with Cd tube) | 0.4563 ± 0.0045 |
| Condition 2 (with Cd tube) | 1.0149 ± 0.0042 |
| Condition 3 (with Cd tube) | −0.9976 ± 0.0045 |
| Condition 2 (without Cd tube) | 0.8877 ± 0.0058 |
| Condition 3 (without Cd tube) | −0.8858 ± 0.0116 |

Table 1 shows that very high spin polarization P are obtained under the conditions 2 and 3 with the Cd tube installed. Under the condition 2 with the Cd tube installed, the polarization P obtained is greater than 1 even in consideration of a statistical error. A conceivable reason for this is that the background level obtained when the background data was measured differs from the background level obtained when the data on the polarization was measured. It is considered that slight fluctuation in background level, which is usually negligible, affected the result since the polarization P of the beam were very high in the experiments.

To address this problem, an experiment is carried out by alternately repeating the measurements of the polarization and the background measurement in a short period of time in order to take into account of systematic errors. The experimental setup used in the experiment was similar to that shown in FIG. 5 except that the defect of the detector signal processing circuit, which caused the streaks observed in FIG. 6, was fixed. The measurement period per measurement was 600 sec, and a series of measurements under the following three conditions was repeated 43 times.

Condition 1: The spin flipper (18) is off.

Condition 2: The spin flipper (18) is on.

Condition 3: BG (the beam shutter is closed)

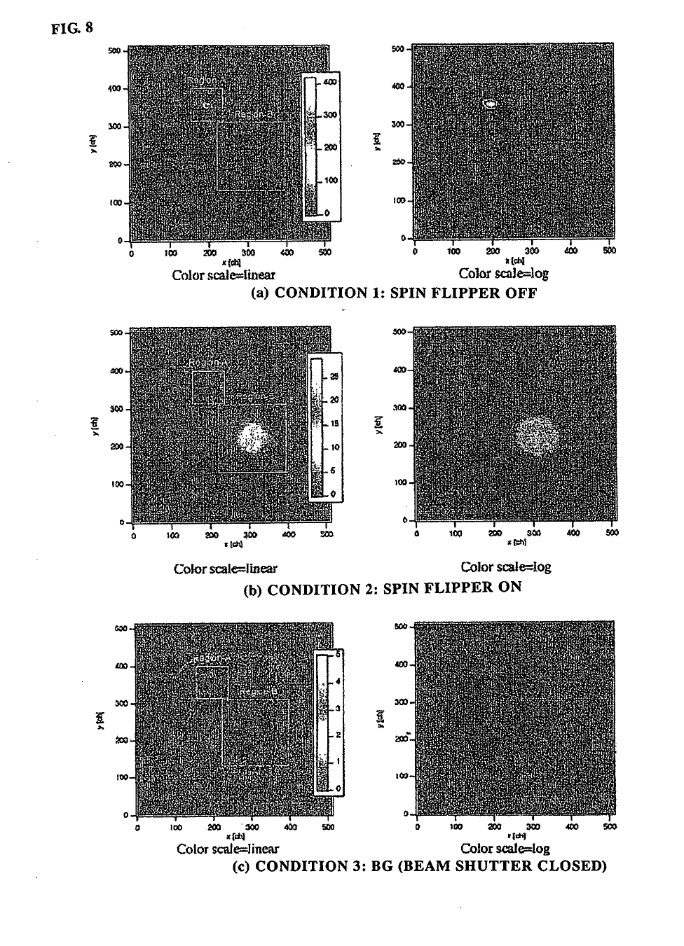

Each figure in FIG. 8 shows accumulated neutron intensity distribution data measured under the same condition. Then, the equation (1) was used to evaluate the polarization P of the neutron beam, as in the case described above. Table 2 shows the resultant polarization. There was not observed any polarization greater than 1, but reasonable values were obtained.

TABLE 2

| Conditions | Polarization P |
|---|---|
| Spin Flipper (18) OFF | 0.9993 ± 0.0059 |
| Spin Flipper (18) ON | −0.9987 ± 0.0059 |

Next, a Halbach-type quadrupole magnet was used as the neutron polarizing element in an experimental setup for focusing-type small-angle scattering experiments so as to evaluate the neutron focusing characteristics of the superconducting sextupole magnet. FIG. 9 diagrammatically shows the configuration of the experimental setup. In FIG. 9, the same elements as those in FIG. 5 have the same reference characters. In FIG. 9, reference numeral (23) denotes a vacuum chamber. Reference numeral (24) denotes an Si window. Reference numeral (25) denotes an Al window.

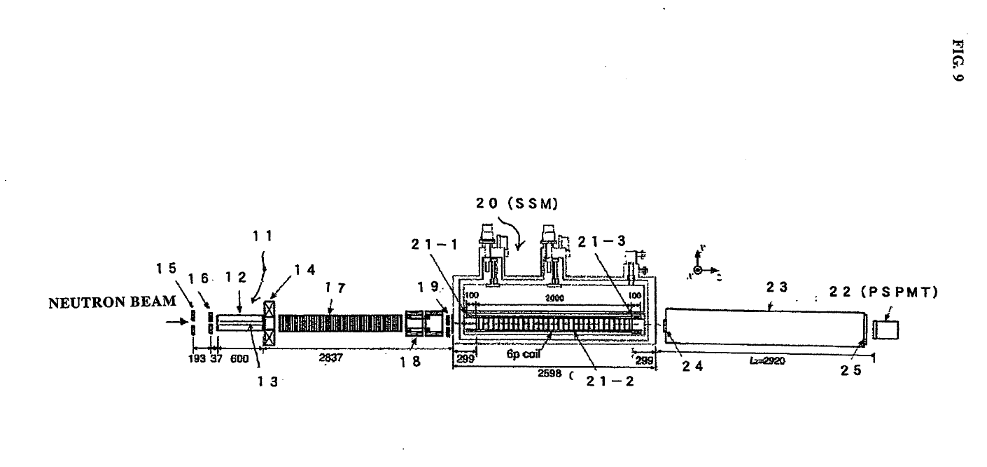

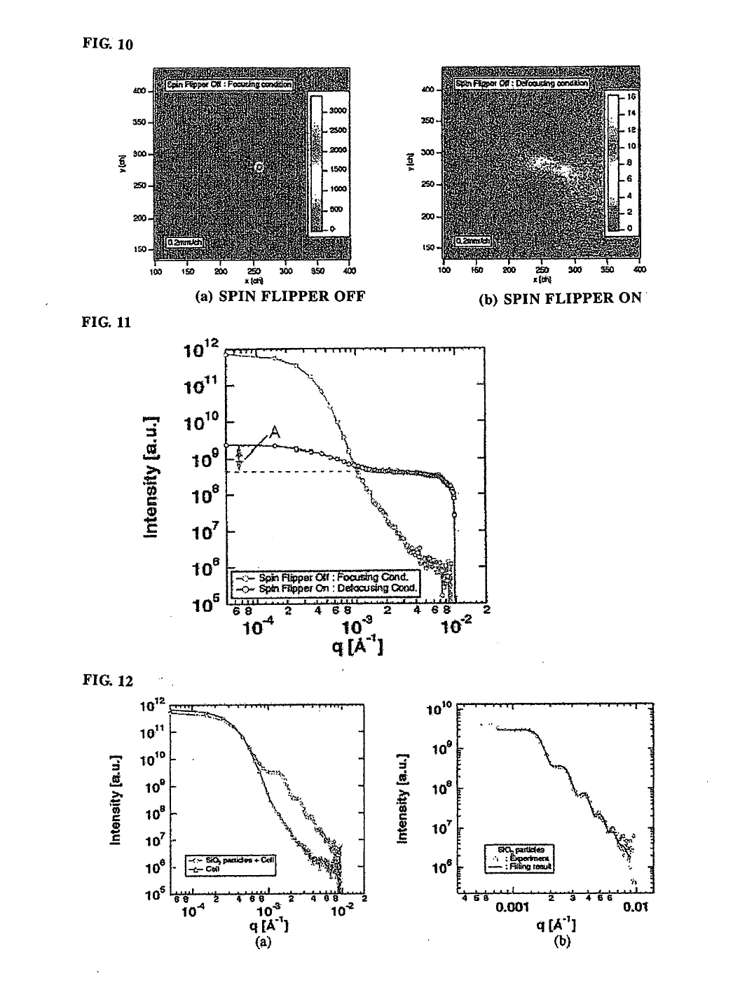

The position-sensitive photomultiplier (PSPMT) (22) was used for carrying out the measurement under the on or off condition of the spin flipper (18). The measurement period was 4800 see for each of the two conditions. FIG. 10 shows the resultant two-dimensional intensity distributions of the neutron intensity. FIG. 11 shows radial average values for the two conditions. FIGS. 10 and 11 show that the polarization P of the neutron beam obtained in the experiments are much higher than those obtained before. FIG. 11 shows that the intensity ratio of the peak value to the background level in the neutron intensity distribution reaches a point as high as approximately 10⁶ because the contamination of the negative polarity component was effectively blocked when the spin flipper (18) was turned off. Further, when the spin flipper (18) was turned off, FIGS. 10(a) and 11 show that a slight amount of neutrons gathered at the center. The reason of this is considered to be the fact that the polarization P of the neutron beam was not exactly 1, that is, slightly contained opposite-polarity neutrons were focused through the superconducting sextupole magnet (SSM) (20). From the peak value (A in FIG. 11), the amount of opposite-polarity components was estimated to be approximately 0.26% of the total neutrons. From this value, the polarization P of the neutron beam was estimated to be 0.995.

Next, on a trial basis, the experimental setup was used to measure small-angle scattering of easily mono-dispersible SiO₂ particles having an average particle diameter of 500 nm. FIG. 12 shows the measurement results. An oscillation pattern that reflects the particle shape was clearly observed. Then, the following equations were used to fit the intensities of scattering from particles.

I(q)∝∫exp[−(q−q′)²/(2Δq²)]×S(q′)∫exp[−(R−Rₘₑₐₙ)²/(2σ_{R}²)]F(q′)²dRdq′ (18)

S(q)=1/[1+24ηG(R_{HS}q)/(R_{HS}q)] (19)

G(x)=α(sin x−x cos x)/x²+β[2x sin x+(2−x²)cos x−2]/x³+γ{−x⁴ cos x+4[(3x²−6)cos x+(x³−6x)sin x+6]}/x⁵ (20)

α=(1+2η)²/(1−η)⁴ (21)

β=−6η(1+η/2)²/(1−η)⁴ (22)

γ=ηα/2 (23)

Table 3 shows the parameters obtained by the fitting. FIG. 12(b) also shows the fitting result, which is indicated by the solid line. The fitting function successfully represented the experimental results very well.

TABLE 3

| Parameters | Fitting Result |
|---|---|
| Rₘₑₐₙ | 240.91 ± 2.17 nm |
| σ_{R} | 12.422 ± 2.14 nm |
| R_{HS} | 392.02 ± 8.14 nm |
| η | 0.41148 ± 0.0115 |

As described above, according to the example of the present invention, significantly high polarization P, which are greater than 0.99, have been obtained. Such high polarization are difficult to achieve by using a magnetic mirror. Further, when a quadrupole magnet is used, there is no neutron absorption and the transmittance of neutrons is 100%, which is also worth noting. A quadrupole magnet having a high polarization capability and a high transmittance capability is believed to be an optimum element, in particular, as a polarizing element in a focusing-type small-angle scattering apparatus using a magnetic lens.

1. A neutron polarization apparatus that provides a neutron beam polarized by an interaction between a spin of a neutron in an incident beam and a magnetic field, comprising:
a quadrupole magnet disposed around a passage of a neutron beam;
a tubular neutron absorber provided in the quadrupole magnet along an axial direction of the neutron beam; and
a solenoid coil disposed at an exit of the quadrupole magnet, adiabatically coupling the quadrupole magnetic field produced by the quadrupole magnet and applying a bipolar magnetic field.

2. The neutron polarization apparatus according to claim 1, characterized in that the quadrupole magnet is a four-piece magnet.

3. The neutron polarization apparatus according to claim 1, characterized in that the quadrupole magnet is a Halbach-type magnet.

4. The neutron polarization apparatus according to claim 1, characterized in that the quadrupole magnet is an advanced Halbach-type magnet.

5. The neutron polarization apparatus according to claim 1, characterized in that the neutron absorber is made of Cd.

6. The neutron polarization apparatus according to claim 2, characterized in that the neutron absorber is made of Cd.

7. The neutron polarization apparatus according to claim 3, characterized in that the neutron absorber is made of Cd.

8. The neutron polarization apparatus according to claim 4, characterized in that the neutron absorber is made of Cd.
